(19) United States
(12) Patent Application Publication
(10) Pub. No.: US 2011/0209711 A1
(43) Pub. Date: Sep. 1, 2011

(54) Multilayer Composition for a Breathing Mask

(76) Inventor: Vianney Brillat, Iguerande (FR)

(21) Appl. No.: 13/060,464

(22) PCT Filed: Aug. 6, 2009
(86) PCT No.: PCT/FR2009/000985

§ 371 Date: May 6, 2011

(30) Foreign Application Priority Data
Aug. 26, 2008 (FR) 0804700

(51) Int. Cl. A62B 7/10; B01D 39/04

(52) U.S. Cl. 128/206.19; 55/486

(57) ABSTRACT

Multilayer filtering composition for a protective breathing mask, characterized in that this filtering multilayer composition comprises, from the outside in: a) an external layer made of a spunbonded nonwoven fabric; b) a first intermediate layer of felt-type tribocharged nonwoven fabric based on at least two different types of fibres suitable for giving the fabric opposite electric charges that enhance the filtration; c) at least one second intermediate layer made of a nonwoven ply of melt-blown microfibres, said ply being charged with static electricity; and d) an internal layer in contact with the face made of a spunbonded nonwoven fabric.

### FIELD OF THE INVENTION

The invention relates to a multilayer filtering composition for a single-use protective breathing mask, against any particle in suspension in the air that has dimensions that can reach the sub-micronic area increasing the performance of the inspiration-expiration pair and rendering it at least equivalent to that of the single-use masks provided with breathing valves.

The invention relates to the use of this multilayer filtering composition in the production of protective breathing masks in particular for intense physical professional activity, making it possible to abandon the single-use breathing mask provided with a breathing relief valve (valve).

### PRIOR ART

A protective breathing mask generally includes a portion intended for contact with the face covering the nose and the mouth, made of one or several layers of filtering material made integral by their glued or welded edges, placed on the face in a sealed manner and maintained in contact with the face via means for fastening.

Protective breathing masks must meet current standard constraints, in particular concerning leaks towards the inside, the penetration of the filtering media by means of specific agents at pre-established flows of air, the breathing resistance in the inspiration or expiration directions at pre-established flows of air.

Single-layer or multilayer protective breathing masks exist in prior art of which the breathing performance is limited to a use that does not require substantial physical effort, i.e. to those that require an important and substantial increase in the flows of air and a greater intake of oxygen for the user of the mask who would have a feeling of smothering, a quick increase in the heart rhythm and the beginnings of asphyxia.

US 2008/0110469 describes a protective breathing mask of ovoid shape of which the contour is provided with an adhesive tape. The mask is comprised of two filtering layers, an internal layer of a felt-type tribocharged fabric and an external layer of a melt-blown nonwoven material. An anti-odour layer can also be provided. Due to its fastening by means of an adhesive tape, this type of mask can irritate the skin and create feelings of discomfort. Moreover, according to the climatic conditions and/or the type of skin of the wearer, the adhesive tape can become detached and the mask can then lose its filtration effectiveness.

Several documents of prior art, such as U.S. Pat. No. 1,556,679, U.S. Pat. No. 3,664,335 or U.S. Pat. No. 4,195,629, describe protective breathing masks provided with fastening clips and composed of three layers, in particular a media layer of the fibrous type or foam sandwiched between two nonwoven external layers. These masks, having good flexibility and allowing for a good passage of the air through their layers during breathing, do not form however a very effective barrier against particles of small size, such as very fine dust or micro-organisms.

Always striving for better-performing filtration, other documents, such as EP 0 183 059, U.S. Pat. No. 5,467,765 describe flexible breathing mask made from a stack of four layers. The document EP 1 014 815 describes a breathing mask made of several layers of which a first outside layer in a nonwoven trilaminated material obtained by spinning-burling/extrusion/spinning-burling (SMS), an intermediate layer in an electret and an inside layer made from an overlay formed by wet method, or a layer obtained by spinning-burling or a trilaminated nonwoven identical to that of the outside layer (SMS). Such a stack of successive layers is, of course, beneficial for the filtration, but substantially resists the respiration, which is tiring and uncomfortable for the user. Moreover, defects in sealing between the mask and the face can appear during expiration, causing the mask to be released from the face and it no longer correctly fulfils the function of filtration.

There are also multilayer protective breathing masks of which breathing performance is enhanced by the presence of a relief valve (valve) for a substantial increase in the flows of air during the expiration of a user of the mask providing professional work and/or requiring physical effort causing an increase in the respiration rate and in the volume of air needed to maintain this work at the level required for its execution without there being a feeling of smothering which could cause the user to remove the protective mask in order to return to a normal breathing capacity.

Such a solution has been proposed in US 2004/0255946 wherein the multilayer mask is provided with a relief valve (valve) intended to resist the inhaled air and to open up to exhaled air. Although facilitating the passage of the exhaled air, the inspiration however remains difficult with such masks due to a lack of specific work on the effort of inspiration. Moreover, the filtration is done generally on a small surface of the total surface of the mask and, in addition, this surface is concealed by the relief valve (valve), thus further reducing its dimensions. Another disadvantage with this type of mask is its weight which is clearly heavier than the weight of a mask without a relief valve (valve), which can be a constraint over time for the wearer of the mask.

In practice, wearers of breathing masks consume, when they are at rest, a magnitude of 30 litres of air per minute and, during physical efforts or when they are providing work, they consume a magnitude of 90 litres of air per minute. It then appears that the filtration capacity and the flows of air delivered by a simple inspiration or expiration protective breathing mask is defined and limited by the composition of the filtering layer or layers, the flows of air per minute and the filtration capacities of the composition being concerned in particular by the quality of the textile or paper fibres comprising their dimensioning, their origin, through the methods practiced for the manufacture of the layer or layers implemented in the production of the mask, the binder used during the formation of the layer or layers, in order to create suitable inter-fibre cohesion and porosity to the air.

As such, faced with the difficulty in changing the capacity of single- or multilayer breathing masks with a precise initial composition in the predetermined limits of flows of air per minute, the simple breathing mask, regardless of the composition of the layer or layers, has been provided with a breathing relief valve (valve) in order to artificially increase the flow of exhaled air in order to remove the impression of smothering of the user of a protective breathing mask, when this user passes from a quasi-idle state to a state of physical work that requires a higher flow of air.

However, providing a single- or multiplayer breathing mask with a breathing relief valve (valve) allowing at least a more rapid expiration of the inhaled and used air when it passes in the airways of the user is at the origin of disadvantages of which certain ones are major, such as:
the increase in the weight of the simple mask, which can be multiplied by a factor 5 or 6, and becomes a substantial hindrance for the user;
an inspiration capacity which is not changed much which requires of the user in a state of physical work, much more effort for a volume of air required that is necessarily increased by the effort;
a loss of a portion of the total inspiration surface of the breathing mask, of a magnitude of 7% to 12% occupied by the location of the relief valve (valve);
the obligation of a change in the shape of the breathing mask in order to provide it with a receiving surface required for the mounting of a valve.

### OBJECT OF THE INVENTION

The objects assigned to the invention are multiple and diverse as they stem from the disadvantages observed with the breathing masks described in prior art, as well as from the needs which are in particular technical which appear during the use of protective breathing masks in various fields in the widest sense of the term, such as for example that of industry, construction and public works or that for medical use requiring improved breathing capacity.

A first object is to create a new-generation breathing mask of which the weight does not exceed that of the simple single- or multilayer breathing masks of prior art (from 5 g to 8 g) through the removal of the relief valve (valve) present on the single- or multilayer protective breathing masks of prior art, and which have enhanced breathing performance for a user providing a physical effort, said new-design breathing mask having at least the same breathing capacity as that of a breathing mask of prior art provided with this relief valve (valve).

Another object is to create a new-generation protective breathing mask, without relief valve (valve), but of which the design provides it with at least the same breathing capacity as that of a protective breathing mask provided with a relief valve (valve) giving it when it is used a multi-functional nature, allowing for the use of said mask when the user who wears it is carrying out a low physical effort as well as when carrying out an intense physical effort.

Another object is to increase the breathing capacity of the protective breathing mask which is measured by a volume of air per minute passing through the breathing mask.

Another object aims to propose a protective breathing mask that is simplified and lightened, but able to facilitate for the user of the mask the inspiration as well as the expiration of the air through said mask in such a way that during inspiration he does not experience a feeling of effort and that during expiration the mask does not move away from the face, as such ensuring an effective filtration and protection of its user.

Another object aims to propose a protective breathing mask able to filter very fine particles, for example dust or micro-organisms, while still improving the performance of the inspiration/expiration pair, even during substantial physical effort.

Another object of the invention is a protective breathing mask able to provide good protection against harmful liquid or solid particles, while still being ergonomic and comfortable to wear.

Another object of the invention is an effective protective breathing mask, providing the user with breathing comfort, while still being able to be manufactured economically in large series.

Another object of the invention is a protective breathing mask of which the manufacture can be easily automated and which, through the suppression of the relief valve (valve), allows for a considerable reduction in the cost price.

Another object of the invention is a protective breathing mask making it possible to substantially reduce the use of fossil raw materials during its production.

### SUMMARY OF THE INVENTION

As such, all of the disadvantages revealed by the use of protective breathing masks of prior art are removed, and the various targeted objects are achieved by the invention.

The invention relates to a multilayer filtering composition for protective breathing mask, characterised in that this multilayer filtering composition comprises from the outside in:
a) an external layer made from a spunbonded nonwoven fabric;
b) a first intermediate layer of felt-type tribocharged nonwoven fabric, made from a base of at least two different types of fibres able to give the fabric opposite electrical charges that enhance the filtration;
c) at least one second intermediate layer made from a nonwoven ply of melt-blown microfibres, said ply being charged with static electricity; and
d) an internal layer in contact with the face made from a spunbonded nonwoven fabric.

### DETAILED DESCRIPTION OF THE INVENTION

The multilayer filtering composition according to the invention for protective breathing mask results in a filtration capacity and a breathing capacity that are at least equal to those of a single- or multilayer protective breathing mask provided with a relief valve (valve), although said composition is devoid of such a relief valve (valve).

According to the invention, the composition comprises a first and a second intermediate layer intended more particularly to carry out an effective filtration placed between two end layers forming a support for the whole, each layer having been selected for its composition from among the layers intended for the production of breathing masks having simultaneously filtration capacities (making it possible to filter fine and sub-micronic particles) and breathing capacities (making it possible to reduce the breathing effort).

As such, the end layers include an external layer and an internal layer, each made of a spunbonded nonwoven fabric able to provide mechanical resistance to the whole and to support the intermediate filtering layers.

The first intermediate layer selected is a felt-type tribocharged nonwoven fabric, made from a base of at least two different types of fibres able to give the fabric opposite electrical charges that enhance the filtration. This first intermediate layer is an electrostatically charged filtering media comprising at least two fibres having different electrical properties which are transformed, during their manufacturing method, in such a way that a transfer of charges is created between two different types of fibres and that discrete, positive and negative charges, are present on the surface of the fibres. As one of the fibres of this filtering media is a very good insulator, the charge transfer is stable and permanent. This first intermediate layer therefore has very good filtration properties, it is able to retain particles that have dimensions less than the micron, while still being able to be produced with a base of rough fibres, which offer a low resistance to the passage of the air through this filtering media.

The second intermediate layer selected is a nonwoven ply of melt-blown microfibres charged with static electricity. This layer is able to retain even finer particles, such as viruses or bacteria. This is a fabric of the electret type, charged with static electricity in such a way as to retain on its surface the particles that are in suspension in the air. Such a layer also forms a barrier to the particles of liquid in suspension in the air.

The arrangement of the layers in the composition of the invention follows an exact order, more particularly, by arranging, from the outside in, after a first support layer, first the first intermediate layer made of felt-type tribocharged nonwoven fabric, then the second intermediate layer made of a nonwoven ply of melt-blown microfibres, charged with static electricity. This arrangement makes it possible to obtain a selective filtration of the particles in suspension, with particles having larger dimensions retained by the first intermediate layer and the finer particles by the second one. This makes it possible to obtain an effective filtration, without immediate clogging of the filtering layers, which makes it possible to have a functional mask for a duration of use that is at least equivalent to that of breathing masks of prior art. Moreover, as the second intermediate layer is the first filtering layer to come into contact with the air exhaled by its wearer, it effectively stops the liquid particles in suspension in blown air, preventing its emission into the surrounding air.

The tests carried out in diversified environments where the users were performing physical efforts at different levels of intensity, have shown that, with such a composition for protective breathing mask, the resistance offered to the passage of the flow of air, during inspiration as well as expiration, was clearly less than the values established by the current standards. This was obtained without arrangement of a breathing relief valve (valve), in order to finally obtain an increased breathing and filtration surface for an extremely low weight.

As such, the weight of a mask produced with such a composition is less than or equal to 6 g which is much less than the masks of prior art, in particular those comprising a breathing relief valve (valve). In addition to its reduced weight, such a mask has a soft touch and allows for the reduction, and even the removal, of the transpiration and prevents the formation of mist which provided its wearer with increased comfort.

More preferably, the first intermediate layer has a resistance to the passage of a flow of air at an average speed of 8.2 m/min which is less than 10 Pa.

Advantageously, the first intermediate layer has a grammage of approximately 50 g/m² to 100 g/m². More preferably, its thickness is approximately 1.3 mm to 2 mm (before implementation).

According to an advantageous characteristic of the invention, the first intermediate layer is chosen in such a way that the penetration of particles of sodium chloride of 0.6 μm with a flow of air having an average speed of 9.5 m/min is (it is understood that it reaches in laboratory conditions) 31% for a first intermediate layer having a grammage of 50 g/m² and 10.2% for a first intermediate layer having a grammage of 100 g/m²,

Advantageously, the fibres which comprise the first intermediate layer have a fibre diameter of approximately 20 μm to 25 μm.

More preferably, these fibres comprising the fabric of the first intermediate layer are selected from among the natural fibres, such as wool, cotton, linen, silk, animal hair; or from among the artificial fibres, such as viscose, cellulose acetate, cellulose triacetate, rayon; or from among the synthetic fibres, such as polyimide, polyvinyl alcohol, polyester, acrylic, polyolefin (polyethylene, polypropylene and their copolymers), polytetrafluoroethylene, vinyl polychloride, polyuruthane; these fibres able to be taken alone or as a mixture.

According to another characteristics of the invention, the second intermediate layer is made from a base of two superimposed layers of polypropylene fibres each having a surface density between 27 g/m² and 64 g/m².

Advantageously, the second intermediate layer is chosen in such a way that the resistance that it offers to the passage of a flow of air having a flow rate of 32 l/min is approximately 26 Pa for a second intermediate layer having a grammage of 27 g/m² and it is approximately 50 Pa for a second intermediate layer having a grammage of 64 g/m².

More preferably, the thickness of the second intermediate layer (12) is between 0.2 mm and 0.8 mm.

The thicknesses of the different layers are selected in order to obtain a composition for breathing mask which is in compliance with the current standards that are specific to the different types of protection. The protective breathing masks are classified, according to the European standard EN149, into three classes of protection: FFP1, FFP2 and FFP3 and, according to the American nomenclature NIOSH, in N95 and N99. The classification of filters relates to their filtration capacity against particles of a certain size, limited to approximately 0.6 μm, this is 95% for FFP2 and N95 masks and 99% for FFP3 and N99 masks.

Advantageously, the penetration of particles of sodium chloride with a flow of air having a flow rate of 32 l/min is 3% for a second intermediate layer having a grammage of 27 g/m² and 0.2% for a second intermediate layer having a grammage of 64 g/m².

More preferably, the second intermediate layer is carried out with a polypropylene microfibre base.

Advantageously, the internal layer and the external layer are made from a nonwoven spunbonded needlepointed fabric, its grammage being between 10 g/m² and 30 g/m², more preferably 20 g/m².

More preferably, the breathing resistance to inspiration measured with a flow of 95 l/min passing through its layers is less than 100 Pa. By way of example, the breathing resistance to inspiration measured during tests carried out with a mask of the FFP3 (or N99) type was approximately 93 Pa to 99 Pa, the tests carried out with masks of the type FFP2 (or N95) type established the values of the resistance to expiration of approximately 43 Pa to 50 Pa and the tests carried out with masks of the FFP1 type established the values of the resistance to expiration of approximately 40 Pa to 47 Pa.

Advantageously, the breathing resistance to expiration measured with a flow of 160 l/min passing through its layers is less than 175 Pa. By way of example, the breathing resistance to expiration measured during tests carried out with a mask of the FFP3 (or N99) type was approximately 159 Pa to 172 Pa, the tests carried out with masks of the FFP2 (or N95) type established the values of the resistance to expiration of approximately 76 Pa to 86 Pa and the tests carried out with masks of the FFP1 type established the values of the resistance to expiration of approximately 71 Pa to 75 Pa.

The purposes of the invention are also achieved with a protective breathing mask comprising a composition according to the invention. Such a mask provides increased breathing comfort for a high filtration capacity.

Advantageously the protective breathing mask of the invention has a weight which is less than or equal to 6 g.

This invention further relates to the use of a composition according to the invention for a protective breathing mask in the field of hygiene and of health, of environmental protection, of do-it-yourself activities, in the food industry, in clean rooms, in construction and public works, in the metallurgy industry, in the automobile industry and more widely in all fields of activity wherein operators are placed in contact with dust and particles.

### DESCRIPTION OF THE DRAWINGS

The annexed figures show a preferred embodiment of a composition for a protective breathing mask according to the invention and a mask containing it,

wherein:

FIG. 1 shows a top view of the protective breathing mask comprising a multilayer composition according to a preferred embodiment of the invention;

FIG. 2 is a transversal cross-section view showing the stack of layers of the mask in FIG. 1.

### DETAILED DESCRIPTION OF A PREFERRED EMBODIMENT OF THE INVENTION

List of Marks:

1 protective breathing mask

2 peripheral edge

3 fold

4 lateral edge

5 lateral edge

6 nose bar

7 fastening clip

8 fastening clip

10a external layer

10b internal layer

11 first intermediate layer

12 second intermediate layer

The multilayer filtering composition according to the invention can be applied to breathing masks having diverse shapes, for example masks in the shape of a shell, duckbill, parrot beak, or others.

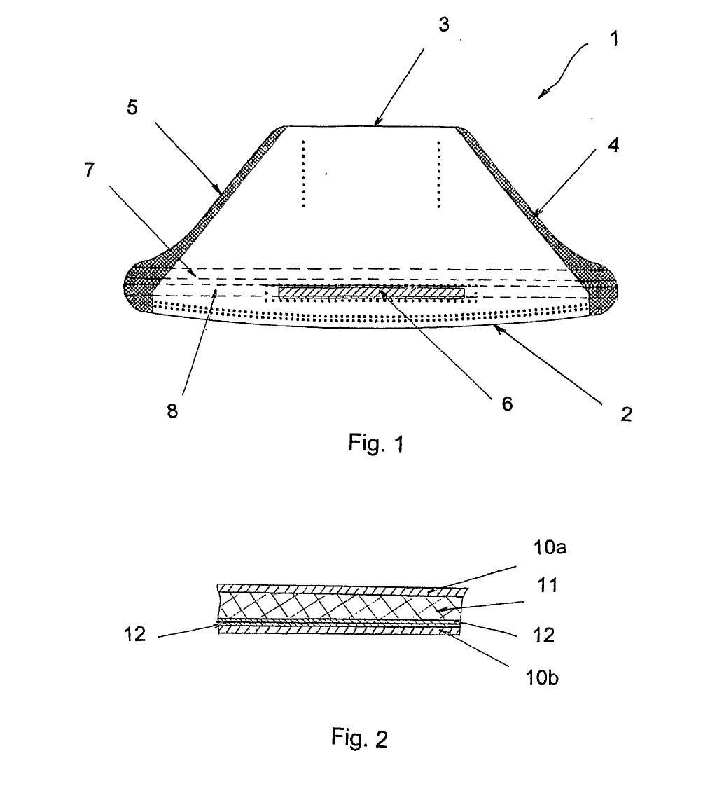

The protective breathing mask 1 shown in FIG. 1 is of the “duckbill” type. The mask is made from a uniform stack of flexible layers, such as shall be explained in what follows. In order to facilitate its conditioning, it is folded according to its longitudinal plane of symmetry and it then has a general trapezoidal shape.

The mask comprises a peripheral edge 2 connected to lateral edges 4, 5 extended by a fold 3 located in a frontal area coming across from the mouth of the user when it is worn. The mask further comprises a nose bar 6 and two fastening clips 7, 8. The nose bar 6 is arranged in an external layer in a nonwoven material and is in relief on the external face of the mask. The fastening clips are elastic, with each one being fixed to the inside of the lateral edges 4, 5.

The nose bar 6 is made from a malleable and non-extendible plastic or metal material allowing the mask to be adapted to the morphology of the face and as such carry out its adjustment in order to reduce the leaks which could occur between the mask and the face.

Such as shown, in FIG. 2, the protective breathing mask 1 of the invention comprises a stack of filtering and support layers composed, from the outside in, of: an external layer 10a, a first intermediate layer 11, two second intermediate layers 12 and an internal layer 10b.

The mask of the invention is designed to isolate and protect its wearer from the risks of inhalation of infectious agents that can be transmitted through the air, such as dust, pollution, virus, allergens, etc. Current standards concerning masks exist in various countries, standards that have specific characteristics, but must, on the overall meet identical requirements. By way of example, these masks are classified according to:
three levels of protection in the European legislation: FFP1, FFP2 and FFP3 and must comply with the requirements of the European standard EN149: 2001 in particular in terms of complete leak towards the inside, penetration of the filtering media and breathing resistance.
two levels of protection in the American legislation NIOSH: N95-N99

In what follows, a “spunbond” material means a spunbonded nonwoven fabric or webbing obtained by an extrusion technique, the threads obtained having a diameter between 13 μm and 16 μm; and “meltblown” material refers to a nonwoven melt-blown microfibre webbing obtained by a blown extrusion technique, the threads obtained having a diameter between 2 μm and 5 μm.

The internal layer 10b as well as the external layer 10a are made of a nonwoven spunbonded fabric (or of the “spunbond” type) which can be composed of different fibres: polypropylene, polyethylene terephtalate, polyamide, polyethylene, polylactic acid, etc. Such a fabric has good mechanical resistance properties. A combination of these fibres can be used to improve the properties of the fabric, for example by combining its resistance properties with those of soft touch. Chemical additives can further improve the properties of the fabric, for example via an antistatic, antibacterial, etc. treatment. In the example described, the internal layer 10b and the external layer 10a are each made of a hydrophilic nonwoven spunbonded needlepointed (“spunbond”) fabric of the DIPRYL brand with a surface density of 20 g/m². According to the Edana 20.2-89 test method, the average values of its resistance to traction is 27 kgf/cm² (MD) and 35 kgf/cm² (CD) and the maximum elongation (MD/CD) is at least 35%. This layer forms a support and gives mechanical resistance properties to all of the layers forming the mask, it plays little or no role in the filtration. In the example described, the same spunbonded needlepointed material (having the same physical characteristics or composition) is used for the three types of European masks FFP1, FFP2, and FFP3 or the two types of American masks N95 and N99.

The second intermediate layer 12 is made from at least one nonwoven ply of melt-blown microfibres, for example of polypropylene, charged with static electricity via the Corona effect. This layer has a role of filtration. It is more preferably folded in two when it is installed between the neighbouring layers of the mask, thus providing that, in a preferred embodiment of the invention, the breathing mask 1 comprises two such second intermediate layers 12.

For the masks of the FFP1 and FPP2 (or N 95) type described here, such a layer is for example of the MB08 type of the Hollingsworth & Vose company, has a surface density of 27 g/m², a thickness of 0.31 mm, a penetration to NaCl of 3% (measured with an flow of air of 32 l/min) and a resistance to the passage of a flow of air of 32 l/min of approximately 26 Pa.

For masks of the FFP3 (or N 99) type, such a second intermediate layer 12 is for example of the MB73 type of the Hollingsworth & Vose company, has a surface density of 64 g/m², a thickness of approximately 0.73 mm, a penetration to NaCl (measured with a flow of air of 32 l/min) of 0.2% and a resistance to the passage of a flow of air of 32 l/min of approximately 50 Pa.

More particularly according to the invention, the first intermediate layer 11 is a webbing or a felt-type tribocharged nonwoven fabric, made from a base of at least two different types of fibres able to give the fabric opposite electrical charges enhancing the filtration. More preferably, the resistance to the passage of a flow of air at an average speed of 8.2 m/min through this first intermediate layer is less than 10 Pa. These fibres can be natural fibres, such as wool, cotton, linen, silk, animal hair (camel, goat, lama, etc.) or artificial fibres, such as viscose (which is a cellulose xanthate), cellulose acetate, cellulose triacetate, or rayon, or synthetic fibres, such as polyamide, polyvinyl alcohol, polyester, acrylic, polyolefin (polyethylene, polypropylene and their copolymers), polytetrafluoroethylene, vinyl polychloride, polyurethane, these fibres can be taken alone or as a mixture. The fabric includes a mixture of two fibres able to be selected from among the preceding fibres in such a way that they are charged electrostatically in an opposite manner.

By way of example, this first intermediate layer 11 is made from a base of a mixture of fibres having a diameter of approximately 20 μm to 25 μm, selected in such a way as to have, during their manufacturing process, triboelectric properties and to generate discrete electrical charges of the opposite sign on the surface of the fibres, the fibres being cleaned, mixed, then woollen in order to obtain a controlled network of weight. The criss-crossed networks are fixed via needlepunching on a support made of a spunbonded nonwoven fabric (of the “spunbond” type). Such a material can for example be made from a base of a pair of acrylic and polypropylene fibres, and can be, for example, of the Technostat type from the Hollingsworth & Vose company. The electrostatic properties and its production with a base of rough fibres provides this layer with a high capacity for charging dust, low resistance to the passage of air and good effectiveness against sub-micronic particles.

After numerous tests carried out in the laboratory, the material chosen for the masks of type FFP1 has a surface density of 50 g/m², with the surface density of its support being 15 g/m², a thickness of 1.3 mm, a penetration of NaCl particles (of a diameter of 0.3 μm) of 31% and a resistance to the passage of a flow of air with an estimated average speed of 8.2 m/min of 4.3 Pa.

Additional tests have made it possible to choose a material for the FFP2 (or N95) and FFP3 (or N99) masks of a surface density equal to 100 g/m², the surface density of its support being 15 g/m², a thickness of 2 mm, a penetration of particles (of a diameter of 0.3 μm) of NaCl of 10.6% and a resistance to the passage of a flow of air of average speed of 8.2 m/min estimated at 8.6 Pa.

The mask FFP1 is intended to provide the protection against non-toxic dust, for example cellulose, cotton, flour, clay, plant and animal oils, or against pollution. It can be applied in the textile, food, do-it-yourself, hygiene and cleaning industries.

The results of the tests carried out with a mask of the FFP1 type of the invention have shown a maximum rate of leakage of 2.87% which is therefore clearly less than the maximum rate allowed by the current standard which is established at 22%. The penetration of the filtering media to NaCl was shown to be a maximum of 2.9%, while the maximum rate allowed by the current standard is 20%. The penetration of the filtering media to paraffin oil was shown to be a maximum of 12.4%, while the maximum rate allowed by the current standard is 20%. The breathing resistance to inspiration, when it was measured with a flow of 30 l/min, was established at a maximum of 15 Pa, it is therefore clearly less than the maximum value allowed by the standard which is 60 Pa; and when it was measured with a flux of 95 l/min, was established at a maximum of 47 Pa and it is therefore clearly less than the value in the standard which is 210 Pa. The breathing resistance to expiration, measured with a flow of 160 l/min was a maximum of 75 Pa, also far less than the maximum value allowed by the standard which is 3 Pa.

The mask FFP2 (or N95) is intended to provide protection against dust from concrete, cement, plaster (for example during work involving demolition, bare brickwork, sanding), soft wood (coming from work involving sanding, cutting), fine particles of paint and resin, plastic materials (coming for example from operations of stripping via impact, sanding, etc.); against viruses (avian influenza, SRAS, tuberculosis), against environmental pollution or allergens. It can be applied in industry, construction and public works, do-it-yourself activities, work with wood, the automobile industry, bodywork and health.

The results of the tests carried out with a mask of the FFP2 (or N95) type of the invention have shown a maximum rate of leakage of 8.4% which is therefore less than the maximum rate allowed by the current standard which is established at 11%. The penetration of the filtering media to NaCl was shown to be at a maximum of 1.2%, while the maximum rate allowed by the current standard is 6%. The penetration of the filtering media to paraffin oil was shown to be a maximum of 5.6%, while the maximum rate allowed by the current standard is 6%. The breathing resistance to inspiration, when it was measured with a flux of 30 l/min, was established at a maximum of 16 Pa, it is therefore less than the maximum value allowed by the standard which is 70 Pa; and when it was measured with a flux of 95 l/min, was established at a maximum of 50 Pa and it is therefore clearly less than the value in the standard which is 240 Pa. The breathing resistance to expiration, measured with a flow of 160 l/min was at a maximum of 86 Pa, also far less than the maximum value allowed by the standard which is 300 Pa.

The FFP3 mask is intended to provide protection against asbestos fibres of which the concentration is less than 1 fibre/cm³/h (for example for the handling of materials or diagnostic), rock wool dust, glass-wool (during handling or work with insulation), lead (when sanding paint), hard wood particles, metal smoke; viruses (infectious breathing pathologies), bacteria (such as legionnaires' disease). It can be applied in industry, construction and public works, work with wood, metallurgy and health.

The results of the tests carried out with a mask of the FFP3 (or N99) type of the invention have shown a maximum rate of leakage of 3.25% which is therefore less than the maximum rate allowed by the current standard which is established at 5%. The penetration of the filtering media to NaCl was shown to be at a maximum of 0.14%, while the maximum rate allowed by the current standard is 1%. The penetration of the filtering media to paraffin oil was shown to be a maximum of 0.84%, while the maximum rate allowed by the current standard is 1%. The breathing resistance to inspiration, when it was measured with a flux of 30 l/min, was established at a maximum of 31 Pa, it is therefore less than the maximum value allowed by the standard which is 100 Pa; and when it was measured with a flux of 95 l/min, was established at a maximum of 99 Pa and it is therefore clearly less than the value in the standard which is 300 Pa. The breathing resistance to expiration, measured with a flow of 160 l/min was at a maximum of 172 Pa, also far less than the maximum value allowed by the standard which is 300 Pa.

The surface of the mask of the invention is between 200 cm² and 250 cm². The mask does not include any breathing valve and, therefore, the filtering and breathing surface is increased with better protection performance and breathing comfort. Furthermore, its weight is less than 6 g, which is clearly less than the weight of a mask with a relief valve (valve) which is approximately 12 g to 30 g. The difference in weight is linked to the absence of the relief valve which reduces the consumption of fossil raw materials by as much and consequently reduces the price of the raw materials, and therefore that of the breathing mask.

In the example shown in the figures, the protective breathing mask of the invention is of the flexible and single-use type.

More preferably, the protective breathing mask of the invention is manufactured continuously on the same production line using plies of material corresponding to the layers that constitute the aforementioned layers of the mask. The plies are cut according to the double trapezoidal shape of the patron of the mask, then the contour corresponding to the lateral edges is welded in a sealed manner, more preferably via ultrasound welding. The mask is then folded around fold 3. The fastening clips and the nose bar are added before welding the lateral edges 4 and 5 in a sealed manner. Patterns or symbols can then be printed on the mask. The mask is finally conditioned in a packaging.

Such a mask has a use in the field of hygiene and health, environmental protection, do-it-yourself activities, the food industry, in clean rooms, in construction and public works, in the metallurgy industry and in the automobile industry and more widely in all fields of activity wherein the operators are placed in contact with dust and particles.

1. Multilayer filtering composition for protective breathing mask, characterised in that this multilayer filtering composition comprises from the outside in:
a) an external layer (10a) made from a spunbonded nonwoven fabric;
b) a first intermediate layer (11) of felt-type tribocharged nonwoven fabric, made from a base of at least two different types of fibres able to give the fabric opposite electrical charges enhancing the filtration,
c) at least one second intermediate layer (12) made from a nonwoven ply of melt-blown microfibres, said ply being charged with static electricity; and
d) an internal layer (10b) in contact with the face made from a spunbonded nonwoven fabric.

2. Composition according to claim 1, characterised in that the first intermediate layer (11) has a resistance to the passage of a flow of air at an average speed of 8.2 m/min which is less than 10 Pa.

3. Composition according to one of the preceding claims, characterised in that the first intermediate layer (11) has a grammage of approximately 50 g/m² to 100 g/m².

4. Composition according to one of the preceding claims, characterised in that the thickness of the first intermediate layer (11) is approximately 1.3 mm to 2 mm.

5. Composition according to one of the preceding claims, characterised in that the fibres which comprise the first intermediate layer (11) have a fibre diameter of approximately 20 μm to 25 μm.

6. Composition according to one of the preceding claims, characterised in that the fibres comprising the fabric of the first intermediate layer (11) are chosen from among:
(i) the natural fibres, such as wool, cotton, linen, silk, animal hair; (ii) artificial fibres, such as viscose, cellulose acetate, cellulose triacetate, rayon; (iii) synthetic fibres, such as polyamide, polyvinyl alcohol, polyester, acrylic, polyolefin (polyethylene, polypropylene and their copolymers), polytetrafluoroethylene, vinyl polychloride, polyurethane; these fibres can be taken alone or as a mixture.

7. Composition according to one of the preceding claims, characterised in that the second intermediate layer (12) is made from a base of two superimposed layers of polypropylene fibres each having a surface density between 27 g/m² and 64 g/m².

8. Composition according to one of the preceding claims, characterised in that the resistance offered by the second intermediate layer (12) to the passage of a flow of air having a flow of 32 l/min is approximately 26 Pa for a second intermediate layer (12) having a grammage of 27 g/m² and it is approximately 50 Pa for a second intermediate layer (12) having a grammage of 64 g/m².

9. Composition according to one of the preceding claims, characterised in that the thickness of the second intermediate layer (12) is between 0.2 mm and 0.8 mm.

10. Composition according to one of the preceding claims, characterised in that the second intermediate layer (12) is made with a polypropylene microfibre base.

11. Composition according to one of the preceding claims, characterised in that the internal layer (10b) and the external layer (10a) are made of a nonwoven spunbonded needlepointed fabric.

12. Composition according to one of the preceding claims, characterised in that the spunbonded nonwoven fabric of the internal layer (10b) and of the external layer (10a) has a grammage between 10 g/m² and 30 g/m², more preferably 20 g/m².

13. Composition according to one of the preceding claims, characterised in that the breathing resistance to inspiration measured with a flow of 95 l/min passing through its layers (10a, 11, 12, 10b) is less than 100 Pa.

14. Composition according to one of the preceding claims, characterised in that the breathing resistance to the expiration measured with a flow of 160 l/min passing through its layers (10a, 11, 12, 10b) is less than 175 Pa.

15. Protective breathing mask (1) made with a composition according to one of the preceding claims.

16. Protective breathing mask (1) according to claim 15, characterised in that its weight is less than or equal to 6 g.

17. Use of a composition according to one of claims 1 to 14 for a protective breathing mask in the field of hygiene and health, environmental protection, do-it-yourself activities, in the food industry, in clean rooms, in construction and public works, in the metallurgy industry, in the automobile industry.
